(19) United States
(12) Patent Application Publication
(10) Pub. No.: US 2026/0087302 A1
(43) Pub. Date: Mar. 26, 2026

(54) UNIFIED GRAPH TRANSFORMER FOR FINANCIAL FRAUD DETECTION ON MASSIVE GRAPHS

(71) Applicants: INTERNATIONAL BUSINESS MACHINES CORPORATION, ARMONK, NY (US); MASSACHUSETTS INSTITUTE OF TECHNOLOGY, CAMBRIDGE, MA (US)

(72) Inventors: YADA ZHU, Irvington, NY (US); Xiaojie Guo, Burke, VA (US); Junhong Lin, Medford, MA (US); Shuaicheng Zhang, Blacksburg, VA (US); Julian Shun, Cambridge, MA (US)

(21) Appl. No.: 18/892,332

(22) Filed: Sep. 20, 2024

(51) Int. Cl. G06N 3/042; G06N 3/0499; G06N 3/08

(52) U.S. Cl. CPC G06N 3/042; G06N 3/0499; G06N 3/08

(57) ABSTRACT

A computer-implemented method for modeling graph-structured data using a graph transformer includes applying cross-type attention to a target node of the graph-structured data. The graph transformer is connected to a type-specific feed forward network to allow node features of different node types to be learned differently. Masked label embedding is applied to force learning and a prediction of a node label for a node having a masked label.

### BACKGROUND

The present disclosure generally relates to systems and methods for modeling graph-structured data using graph transformers, and more particularly, to a unified graph transformer that can be used in graphs having both heterogeneity and heterophily.

Graphs have become increasingly prevalent in the real world due to their ability to model complex relationships across various domains. Graph neural networks (GNNs) have been pivotal in achieving state-of-the-art performance on a wide range of graph learning tasks. GNNs were primarily designed for homogeneous graphs associated with a single type of node and edge, and used a neighborhood aggregation scheme to capture the structural information of the graph, where the transformed representation of each node is recursively propagated to neighbor nodes and aggregated via different mechanisms. The neighbor aggregation used in many existing GNNs typically assume that the graph is homophilic, i.e., connected nodes are similar to each other. This kind of dominating GNNs are said to be focused on homogeneous homophilic graphs.

However, many real-world graphs, such as academic networks, social networks, and financial networks, frequently present challenges for graph learning due to heterophily, where connected nodes may have dissimilar labels and attributes, and heterogeneity, where multiple types of entities and relations among the graphs are embodied by various types of nodes and edges. Each of these two properties can significantly impede the performance of GNNs.

While there has been advancements in handling heterophilic and heterogenous separately, there is a lack of research on learning on graphs with both of these two properties, which are present in many real-world graphs. For example, financial transaction networks are both heterophilic and heterogeneous. Different node types (personal account, business account, and the like) and edge types (wire transfer, credit card transaction, and the like) exist, making the graph heterogeneous. The class labels of fraudsters differ from those of their innocent neighbors, making the graph heterophilic. Similarly, in social networks, different node types (user, group, club, and the like) and edge types (friendship, club members, and the like) exist, leading to graph heterogeneity, and user attributes can also differ from their connected friends, resulting in heterophily. There are also many graphs from other industry domains that are heterogeneous and heterophilic, such as networks from e-commerce, academia, and cybersecurity. It remains unclear whether the current heterophilic GNNs or heterogeneous GNNs can effectively handle such kind of real-world graphs, given that no heterophilic and heterogeneous graph benchmarks currently exist. Thus, there is a high demand to explore the graph learning in such integrated settings.

### SUMMARY

In one embodiment, a system, method and computer program product are described that provide a method for modeling graph-structured data, such as data provided in heterogeneous-heterophilic graphs, using a graph transformer. The methods include applying cross-type attention to a target node of the graph-structured data and connecting the graph transformer to a type-specific feed forward network to allow node features of different node types to be learned differently. Masked label embeddings can be applied to force learning and a prediction of a node label.

In some embodiments, the cross-type attention is cross-type heterogeneous attention that focuses on neighbors of the target node and utilizes node/edge type information in the graph-structured data.

In some embodiments, the method further includes simultaneously allowing the target node to communicate with other nodes of different node types.

In some embodiments, the method further includes applying projection matrices on the target node, having a given node type, to generate corresponding key-, query- and value projections to model connections between different types of nodes.

In some embodiments, the method further includes applying an edge-type dependent transformation in the cross-type attention to allow modeling of diverse node relationships.

In some embodiments, the method further includes concatenating as input a randomly masked label embedding to explicitly force the graph transformer to learn and predict the node label.

In some embodiments, the method further includes applying a cross-type attention mask for a node pair without an interconnecting edge to allows the target node to attend to neighbor nodes regardless of the node type.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 shows examples of graphs with different levels of heterogeneity and heterophily;

FIG. 2 shows an overall unified graph transformer (GT) framework, where MM stands for matrix multiplication; FFN stands for feed-forward networks; |A| and |R| are the number of node and edge types, respectively, consistent with an illustrative embodiment;

FIG. 3 shows a table illustrating accuracy results on certain evaluation tasks using various datasets, comparing the unified GT methods, consistent with an illustrative embodiment, with conventional graph transformations;

FIG. 4 shows a flow chart illustrating an overall process for modeling graph-structured data using a graph transformer, consistent with an illustrative embodiment; and

FIG. 5 is a functional block diagram illustration of a computer hardware platform that can be used to implement the method for modeling graph-structured data using a graph transformer, consistent with an illustrative embodiment.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

As described in greater detail below, aspects of the present disclosure provide systems and methods that can model graph-structured data using a unified graph transformer that can be used in graphs having both heterogeneity and heterophily.

Although the operational/functional descriptions described herein may be understandable by the human mind, they are not abstract ideas of the operations/functions divorced from computational implementation operations/functions. Rather, the operations/functions represent a specification for an appropriately configured computing device. As discussed in detail below, the operational/functional language is to be read in its proper technological context, i.e., as concrete specifications for physical implementations.

Accordingly, one or more of the methodologies discussed herein may provide a unified graph transformer that can be used in graphs having both heterogeneity and heterophily. This may have the technical effect of permitting modeling of large graph-structured data. Accordingly, the system and methods according to aspects of the present disclosure provide a substantial improvement to technology and computer functionality.

It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably be processed manually by a human user.

In recent years, transformer models have demonstrated great potential for modeling graph-structured data, and many graph transformers (GT) have been proposed and applied to graph representation learning tasks. However, while GTs are effective, existing GTs have mostly been applied to small graphs, and their critical ingredients for success and the connections among these components when processing large graphs are poorly understood. Through a systematic investigation of using GTs on large graphs, it has been found that (i) explicit graph structure injection through direct neighbor attention masking is significantly more effective than implicitly using graph structure through positional encoding; (ii) combining a direct neighbor-attended GT with a message-passing graph neural network (MP-GNN) boosts accuracy; and (iii) the FFN acts as a semantic mixer and plays a useful role, even though existing GTs neglect the FFN. As part of the current investigation, a modular unified GT framework, called UnifiedGT, is introduced, which is effective at handling both large-scale heterogeneous and homogeneous graph data.

UnifiedGT, a GT for large-scale heterophilic-heterogenous graphs, includes three illustrative components, (1) cross-type heterogeneous attention; (2) type-specific feedforward network (FFN); and (3) masked label embedding. The designed model, consistent with an illustrative embodiment, achieves the state-of-the-art on heterophilic and heterogeneous graph benchmarks.

The graph transformer framework according to aspects of the present disclosure provides features including (1) cross-type heterogeneous attention. This design of an attention mechanism allows focus on the important neighbors of the target node, and can well utilize the node/edge type information in the heterogeneous graph. It is featured as cross-type because it allows a single node to communicate with other nodes of different types simultaneously. (2) Type-specific feedforward network (FFN). This design connects the GT to a type-specific FFN. It allows nodes features of different types to be learned differently and enables modeling of richer relationships. (3) Masked label embedding. This can handle a graph with heterophily, where a randomly masked label embedding is concatenated as input, which explicitly forces the model to learn and predict the node label in place. Details of each of these features are described in greater detail below.

### Definitions

Heterogeneous Graphs. A heterogeneous graph is defined as a directed graph G=(V, E, A, R), where each node v∈V and each edge e∈E is associated with their type mapping function τ(v):V→A and φ(e):E→R, respectively, where A denotes the set of possible node types and R denotes the set of edge types (relations).

Meta Relation. For an edge e=(s, t) linked from source node s to target node t, its meta relation is denoted as <τ(s), φ(e), τ(t)>. A metapath of length n, defined as

$$𝒫 = {A}_{1} {\to }^{{R}_{1}} {A}_{2} {\to }^{{R}_{2}} … {\to }^{{R}_{n}} {A}_{n + 1} ,$$

is a sequence of meta relations, where Aᵢ∈A and Rᵢ∈R. For example, in a citation network, a metapath “paper→author→paper” represents papers written by the same author.

Metapath Induced Subgraphs. Given a metapath P, the corresponding metapath induced subgraph G_{P} can be constructed, which includes edge (u, v) in G_{P} if and only if there exists at least one length-n path between u and v following the metapath P in the original graph G.

Heterophily in Heterogeneous Graphs. Heterophily measure is used in describing the heterophilic property of a graph and is defined based on the dissimilarity between two connected nodes with respect to node attributes/labels. Current heterophily measures are designed for homogeneous graphs, with typical metrics such as edge heterophily quantifying the proportion of edges that connect nodes of the different labels. However, these measures become problematic when applied to heterogeneous graphs. In heterogeneous graphs, relationships are not limited to direct edges between labeled nodes (typically of one type), and can include complex metapaths connecting different types of nodes. For instance, traditional metrics primarily evaluate the heterophily of direct “paper→paper” connections in academic networks, which, however, overlooks significant interactions like “paper→author→paper” metapath. This limitation underscores the need for a new approach to measuring heterophily in heterogeneous graphs.

### Overall Framework of UnifiedGT

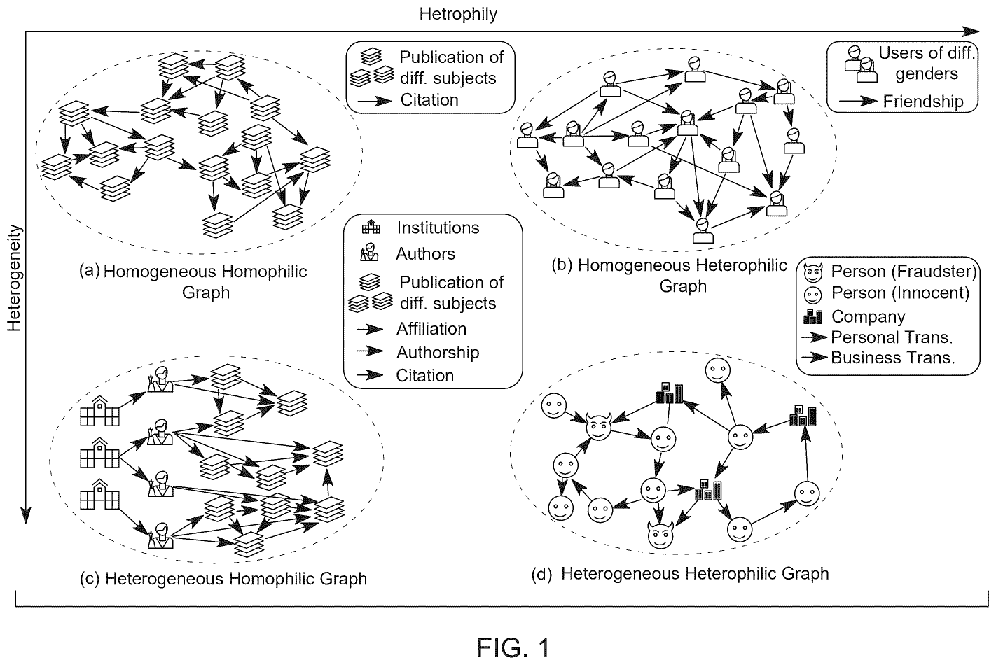

Reference now is made to FIG. 1., which show examples of graphs with different levels of heterogeneity and heterophily. More specifically, section (a) illustrates a homogeneous homophilic portion at a top left portion of the graph. Section (b) illustrates a homogeneous heterophilic portion at a top right portion of the graph. Section (c) of FIG. 1 illustrates a heterogenous homophilic section of the graph, which is at a bottom left portion of the graph. Section (d) of FIG. 1 illustrates an example of a graph having both heterogeneity and heterophily, and is therefore at a bottom right portion of the graph.

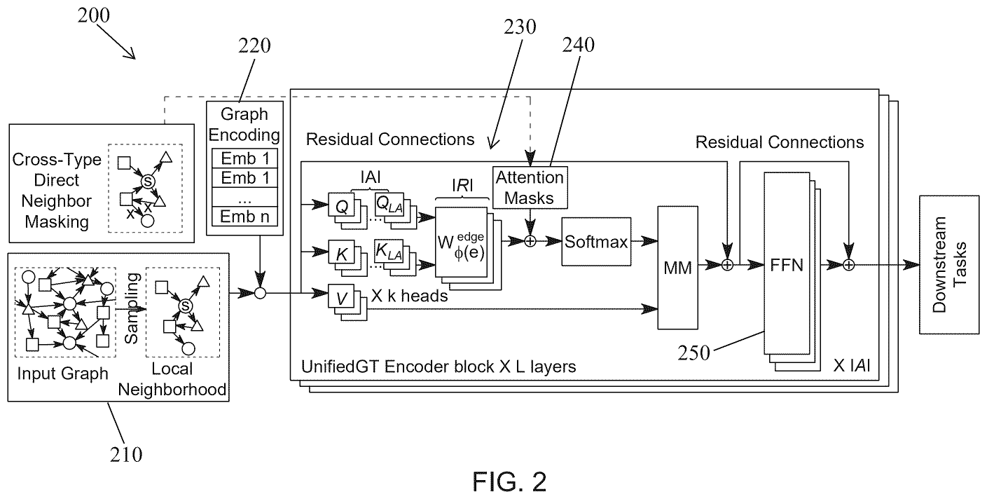

As shown in FIG. 2, a general framework, UnifiedGT 200, includes five modular ingredients: (1) a graph sampling component 210, (2) a graph encoding component 220, (3) a graph attention calculation component 230, (4) an attention masking component 240, and (5) a feedforward network (FFN) component 250. The workflow of UnifiedGT begins with the (1) graph sampling component 210, which selectively extracts a subgraph centered around the target nodes, capturing their local neighborhood. Subsequently, the (2) graph encoding component 220 constructs a hidden feature matrix

$$H = {[ {h}_{1}^{T} , {h}_{2}^{T} , … {h}_{n}^{T} ]}^{T} ϵ ,$$

where d represents the hidden dimension, and hᵢ∈ [symbol] denotes the hidden feature of node i. This step projects each node feature xᵢ through a node-type-specific feature projection, which is then concatenated with a structure-aware graph encoding as hᵢ=W_{T(i)}xᵢ∥Pᵢ. This projection and concatenation process effectively aligns the features from various node types into a cohesive feature space. Following the encoding, H is processed by the (3) graph attention calculation component 230 and integrated through the (4) attention masking component 240, where the graph's structural information is leveraged to refine the node features dynamically based on their neighborhood context. The enhanced features are then fed to the (5) fully connected layers. The refined feature matrix H can be used for downstream tasks such as node classification or link prediction. Following this established workflow, the framework not only able to implement numerous existing graph transformers, but also enable the customization of each modular component to meet specific research needs. The modular and flexible nature of UnifiedGT allows researchers to utilize pre-defined components and seamlessly integrate novel custom components, enhancing the framework's adaptability to new graph learning challenges. Each modular components are described further below.

### Modular Components of UnifiedGT

Graph Sampling. Graph sampling and minibatch training are used for processing large-scale graphs. To extend to large graphs, three standard sampling options are proposed: neighbor sampling, GraphSAINT sampling, and HGSampling. Among them, neighbor sampling and HGSampling are applicable to both homogeneous and heterogeneous graphs.

Graph Encoding. Capturing the graph structure information is useful for graph learning. The following graph encoding options are provided to help encode graph structure information: Node2Vec embedding, Metapath2Vec embedding, and knowledge graph embedding. Besides, to tackle the challenges of graph heterophily, a masked label embedding is provided to improve the model capability to understand node labels, which can be formulated in Equation (1).

$${P}_{label} = {W}_{y} ( Y ∘ M ) , where M \sim Bernoulli ( p ) , p ϵ ( 0 , 1 ) \qquad ( 1 )$$

Through a linear projection, the one-hot label vectors Y extract the label embedding P_{label} and concatenate to the input node features. To avoid information leakage, a portion of node labels are randomly masked during training to force the model to learn reconstructing the node labels. ∘ denotes the Hadamard product.

Attention Calculation. Existing GTs have predominantly been applied on homogeneous graphs, where the attention is calculated by pairwise dot product on the projected key and query vectors. This is denoted as plain attention calculation. To generalize GTs to heterogeneous graphs, the diverse semantics of nodes and edges need to be considered. The design of cross-type heterogeneous attention calculation is introduced to utilize both the node and edge type information. Cross-type heterogeneous attention performs node type-dependent key-, query-, and value projections to model the complex connections between different types of nodes. Concretely, projection matrices W_{K}_{ₜ₍ᵥ₎}, W_{Q}_{ₜ₍ᵥ₎}, and W_{V}_{ₜ₍ᵥ₎}, are applied on the on node v with type τ(v), to generate the corresponding Q, K, and V matrices (See equation (2), below). Besides, to incorporate edge type information, an edge-type dependent transformation W^{edge} φ^{(e)} is designed to allow modeling of diverse relationship (See equation (3), below).

$$Q = {[ {q}_{1}^{T} , … , {q}_{n}^{T} ]}^{T} = {[ {( {h}_{1} {W}_{{Q}_{τ} ( 1 )} )}^{T} , … , {( {h}_{n} {W}_{{Q}_{τ} ( n )} )}^{T} ]}^{T} \qquad ( 2 )$$

$$K = {[ {k}_{1}^{T} , … , {k}_{n}^{T} ]}^{T} = {[ {( {h}_{1} {W}_{{K}_{τ} ( 1 )} )}^{T} , … , {( {h}_{n} {W}_{{K}_{τ} ( n )} )}^{T} ]}^{T}$$

$$V = {[ {v}_{1}^{T} , … , {v}_{n}^{T} ]}^{T} = {[ {( {h}_{1} {W}_{{V}_{τ} ( 1 )} )}^{T} , … , {( {h}_{n} {W}_{{V}_{τ} ( n )} )}^{T} ]}^{T}$$

$$MHA ( {x}_{i} ) = softmax ( \frac{{q}_{i} {W}_{ϕ ( e )}^{edge} {k}_{j}^{T}}{\sqrt{{d}_{k}}} ) {v}_{j} \qquad ( 3 )$$

It is worthwhile to note that typical heterogeneous GNNs only pass messages through specified meta-relations, while the heterogeneous attention, consistent with illustrative embodiments, enables a cross-node-type communication, where a single node can communicate with other nodes of different types simultaneously. Additionally, this new attention is capable to express all the homogeneous graph transformers with the projection matrices fixed to a single set.

Conventional attention applies the same set of projection matrix on all nodes and, unlike aspects of the present disclosure, does not utilize node/edge type information. Further, conventional attention is calculated over all nodes, which requires an infeasible computation and attention dilution on large-scale graphs. Instead, according to aspects of the present disclosure, attention is allowed to cross-type direct neighbors.

Attention Masking. In addition to utilizing graph encodings to introduce structural information, attention masks can be incorporated to reinforce the graph inductive bias. Accordingly, cross-type attention masking is provided for learning heterogeneous graph structure. The attention masking (or bias) mechanism can be formulated as in Equation (4), below, where Aᵢⱼ represents the attention score between node pair (i, j). The added bias is passed through the softmax function to generate an attention score (see FIG. 2). When a negative infinity is added to Aᵢⱼ, it essentially acts as an attention mask and zeroes out the corresponding attention score. Cross-type attention mask is applied for any node pair that is not an edge, and allows a node to attend to any neighbor nodes regardless of their type. It is therefore named cross-type because it allows a single node to exchange messages with other nodes of different types simultaneously.

$$A = {QK}^{T} / \sqrt{{d}_{k}} + B , where {B}_{ij} = \{ \begin{matrix}0 , & if ( i , j ) is an edge , \\ - ∞ , & otherwise .\end{matrix} \qquad ( 4 )$$

With the introduced attention masking (bias) component, UnifiedGT is capable to express graph transformers with attention bias. The heterogeneous graph transformer (HGT) model can also fit into the UnifiedGT framework when only allowing the attention scores to be calculated on meta-relations.

Conventional graph transformers do not explicitly leverage the label information and have worse performance when graph heterophily presents. Aspects of the present disclosure, however, leverage the label information and force the model to predict masked labels, allowing it to overcome the label heterophily challenges.

Type-specific FFNs. The feed-forward network (FFN) is a component of transformer architectures, which can help the model capture more complex patterns and relationships in the data. Type-specific FFNs are provided to accommodate data heterogeneity, which allows the modeling of richer relationships in the semantic space of each individual node type.

Conventional graph transformers use a single set of FFN. This implicitly assumes all node embedding is located in the same semantic space. Aspects of the present disclosure, however, enable a more expressive FFN, which allows the modeling of richer relationships in the semantic space of each individual node type.

### EXPERIMENTS

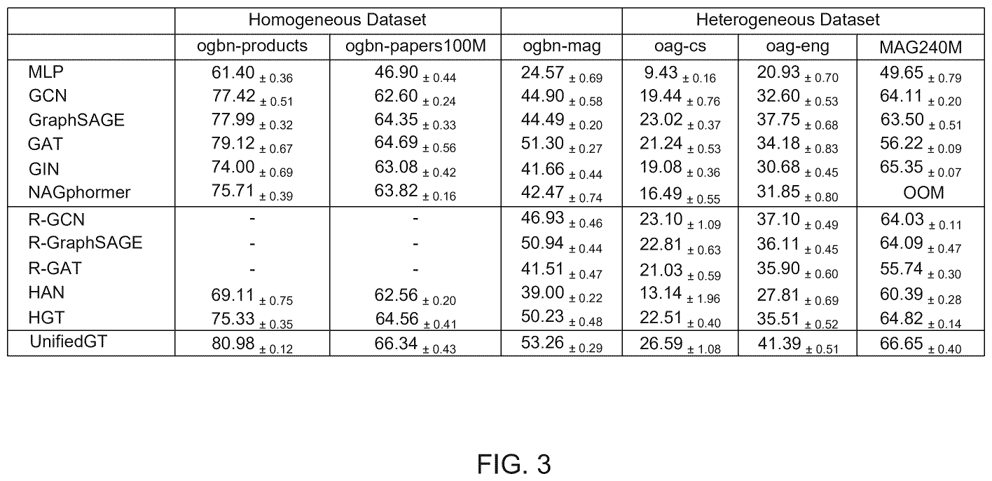

Experiments were conducted with multiple datasets including Open Graph Benchmark (OGB), ogbn-products (Amazon review network), ogbn-papers100M, ogbn-mag, MAG240M (citation network), and Open Academic Graph (OAG). The evaluation tasks were either a product classification task or a paper-venue classification task. The evaluation metric provided on the table shown in FIG. 3 is accuracy of the evaluation tasks.

The UnifiedGT framework, according to aspects of the present disclosure, was compared to baselines, including models that only considers node features, such as MLP, and models that are a first class of GNN baselines, designed for homogeneous homophilic graphs, including GCN, GraphSAGE, GAT, GIN, and NAGphormer. The second class of baselines, optimized for heterogeneous homophilic graphs, includes relational GCN (R-GCN), GraphSAGE (R-GraphSAGE), GAT (R-GAT), HAN, and HGT.

As can be seen, the UnifiedGT framework provided the best accuracy across each of the datasets as compared to several comparative models. Accordingly, UnifiedGT can provide a graph transformer that can be used in graphs having both heterogeneity and heterophily.

### Example Process

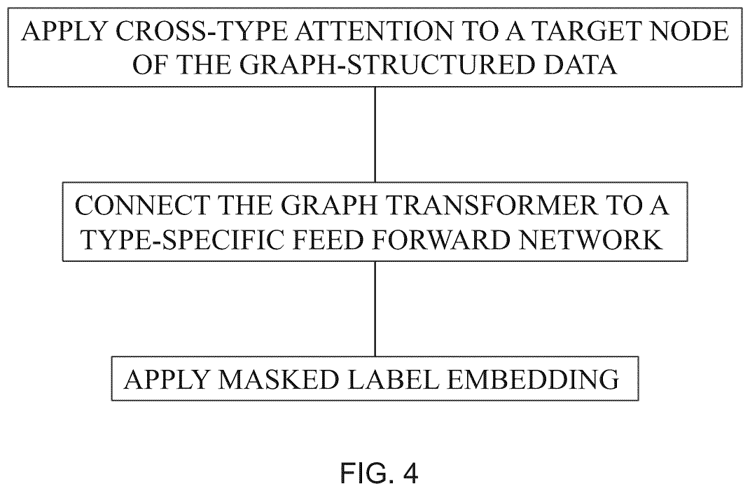

It may be helpful now to consider a high-level discussion of an example process. To that end, FIG. 4 presents an illustrative process 400 related to the method for modeling graph-structured data using a graph transformer. Process 400 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

Referring to FIG. 4, block 402 of process 400, can include an act of applying cross-type attention to a target node of the graph-structured data. The process 400, at block 404, can include an act of connecting the graph transformer to a type-specific feed forward network to allow node features of different node types to be learned differently. Finally, the process 400, at block 406, can include an act of applying masked label embedding to force learning and a prediction of a node label. Details of each of these acts are described in detail above.

### Example Computing Platform

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

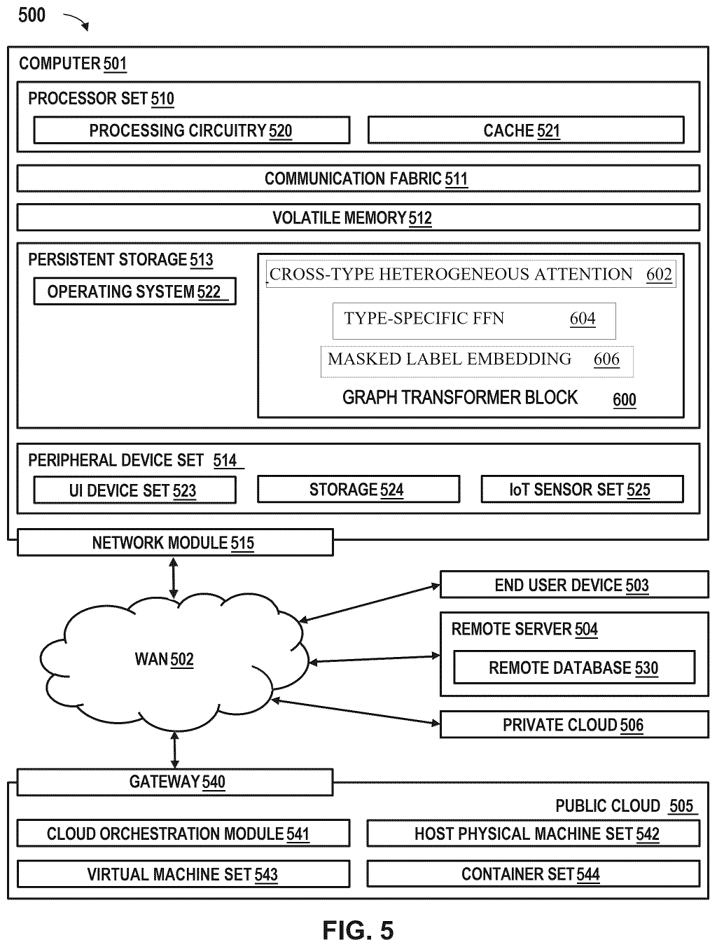

Referring to FIG. 5, computing environment 500 includes an example of an environment for the execution of at least some of the computer code involved in performing the inventive methods, including graph transformer block 600, which can include a cross-type heterogeneous attention component 602, a type-specific feed forward network component 604, and a masked label embedding component 604. In addition to block 600, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 600, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 600 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in block 600 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

### CONCLUSION

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of an appropriately configured computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The call-flow, flowchart, and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method for modeling graph-structured data using a graph transformer, comprising:
applying cross-type attention to a target node of the graph-structured data;
connecting the graph transformer to a type-specific feed forward network to allow node features of different node types to be learned differently; and
applying masked label embedding to force learning and a prediction of a node label.

2. The computer-implemented method of claim 1, wherein the graph-structured data is in a heterogeneous graph.

3. The computer-implemented method of claim 2, wherein the cross-type attention is cross-type heterogeneous attention that focuses on neighbors of the target node and utilizes node/edge type information in the graph-structured data.

4. The computer-implemented method of claim 3, further comprising simultaneously allowing the target node to communicate with other nodes of different node types.

5. The computer-implemented method of claim 3, further comprising applying projection matrices on the target node, having a given node type, to generate corresponding key-, query- and value projections to model connections between different types of nodes.

6. The computer-implemented method of claim 3, further comprising applying an edge-type dependent transformation in the cross-type attention to allow modeling of diverse node relationships.

7. The computer-implemented method of claim 1, wherein the graph-structured data is in a heterophilic graph.

8. The computer-implemented method of claim 7, further comprising concatenating as input a randomly masked label embedding to explicitly force the graph transformer to learn and predict the node label.

9. The computer-implemented method of claim 1, further comprising applying a cross-type attention mask for a node pair without an interconnecting edge to allows the target node to attend to neighbor nodes regardless of the node type.

10. A system comprising:
a processor;
a data bus coupled to the processor;
a memory coupled to the data bus; and
a computer-usable medium embodying a computer program code, the computer program code comprising instructions executable by the processor and configured to:
apply cross-type attention to a target node of graph-structured data;
connect a graph transformer to a type-specific feed forward network to allow node features of different node types to be learned differently; and
apply masked label embedding to force learning and a prediction of a node label.

11. The system of claim 10, wherein the graph-structured data is in a heterogeneous-heterophilic graph.

12. The system of claim 11, wherein the cross-type attention is cross-type heterogeneous attention that focuses on neighbors of the target node and utilizes node/edge type information in the graph-structured data.

13. The system of claim 11, wherein the instructions are further configured to simultaneously allow the target node to communicate with other nodes of different node types.

14. The system of claim 11, wherein the instructions are further configured to apply projection matrices on the target node, having a given node type, to generate corresponding key-, query- and value projections to model connections between different types of nodes.

15. The system of claim 11, wherein the instructions are further configured to apply an edge-type dependent transformation in the cross-type attention to allow modeling of diverse node relationships.

16. A computer program product for modeling graph-structured data in a heterogeneous-heterophilic graph using a graph transformer, the computer program product comprising a computer readable storage medium having program instructions embodied therewith, the program instructions executable by a computer to cause the computer to:
apply cross-type attention to a target node of the graph-structured data;
connect the graph transformer to a type-specific feed forward network to allow node features of different node types to be learned differently; and
apply masked label embedding to force learning and a prediction of a node label.

17. The computer program product of claim 16, wherein the cross-type attention is cross-type heterogeneous attention that focuses on neighbors of the target node and utilizes node/edge type information in the graph-structured data.

18. The computer program product of claim 16, wherein the program instructions are further configured to simultaneously allow the target node to communicate with other nodes of different node types.

19. The computer program product of claim 16, wherein the program instructions are further configured to apply projection matrices on the target node, having a given node type, to generate corresponding key-, query- and value projections to model connections between different types of nodes.

20. The computer program product of claim 16, wherein the program instructions are further configured to apply an edge-type dependent transformation in the cross-type attention to allow modeling of diverse node relationships.
